(19) United States
(12) Patent Application Publication
(10) Pub. No.: US 2025/0219105 A1
(43) Pub. Date: Jul. 3, 2025

(54) METHOD OF MANUFACTURING RIBBON-SHAPED ELECTRODES AND DEVICES THEREFOR

(71) Applicants: VARTA MICROBATTERY GMBH, Ellwangen Jagst (DE); Dürr Systems AG, Bietigheim-Bissingen (DE)

(72) Inventors: Dominik RAUSCH, Bartholomä (DE); Andreas KEIL, Munich (DE); Winfried GAUGLER, Ellwangen (DE)

(21) Appl. No.: 18/837,935

(22) PCT Filed: Feb. 14, 2023
(86) PCT No.: PCT/EP2023/053669

§ 371 Date: Aug. 13, 2024

(30) Foreign Application Priority Data
Feb. 14, 2022 (EP) 22156495.8

(51) Int. Cl. H01M 4/75; H01M 4/04; H01M 10/0525

(52) U.S. Cl. CPC H01M 4/75; H01M 4/0404; H01M 10/0525

(57) ABSTRACT

A method of manufacturing ribbon-shaped electrodes includes providing a ribbon-shaped metal foil and coating the ribbon-shaped metal foil with an electrode material in a continuous process to apply, via a plurality of application nozzles and simultaneously to a first side and to a second side, an equal number of parallel strips of the electrode material. Each respective parallel strip on the first side overlaps with a respective parallel strip on the second side. On both the first side and the second side, an uncoated strip-shaped region between adjacent parallel strips of the electrode material remains free of the electrode material. The method further includes detecting an offset that exceeds a predefined threshold value between overlapping strips on the first side and the second side and correcting, in response to detecting the offset, a position of at least one of the application nozzles relative to the ribbon-shaped metal foil.

### CROSS REFERENCE TO RELATED APPLICATIONS

This application is a U.S. National Phase application under 35 U.S.C. § 371 of International Application No. PCT/EP2023/053669, filed on Feb. 14, 2023, and claims benefit to European Patent Application No. EP 22156495.8, filed on Feb. 14, 2022. The International Application was published in German on Aug. 17, 2023 as WO/2023/152402 under PCT Article 21(2).

### FIELD

The present disclosure relates to a method of manufacturing ribbon-shaped electrodes comprising a ribbon-shaped current collector covered on both sides with a layer of an electrode material and having, on both sides, a region extending along one of its longitudinal edges which is not covered with the electrode material. Furthermore, the disclosure relates to a device for producing such electrodes, to the use of such electrodes, and to electrochemical energy storage elements which can be produced therewith.

### BACKGROUND

Electrochemical energy storage elements can convert stored chemical energy into electrical energy through virtue of a redox-reaction. The simplest form of an electrochemical energy storage element is the electrochemical cell. It comprises a positive electrode and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge of the electrochemical energy storage element is reversible, i.e. it is possible to reverse the conversion of chemical energy into electrical energy during discharge and charge the cell or element again, this is said to be a secondary element. The common designation of the negative electrode as the anode and the designation of the positive electrode as the cathode for secondary elements refers to the discharge function of the electrochemical energy storage element.

In the present case, the term “electrochemical energy storage element” is understood to mean not only a single electrochemical cell but also a battery made up of a plurality of individual electrochemical cells.

WO 2017/215900 A1 describes cylindrical round cells in which an assembly in the form of a winding is formed from ribbon-shaped electrodes. The electrodes each have current collectors loaded with electrode material. Oppositely polarized electrodes are arranged offset to each other within the assembly so that longitudinal edges of the current collectors of the positive electrodes protrude from one end face and longitudinal edges of the current collectors of the negative electrodes protrude from a second end face of the winding. For electrical contacting of the current collectors, the cell has contact plates that sit on the end faces of the winding and are connected to the protruding longitudinal edges of the current collectors by welding. This makes it possible to electrically contact the current collectors and thus also the associated electrodes over their entire length. This significantly reduces the internal resistance within the described cell. As a result, the occurrence of large currents can be absorbed much better and heat can also be dissipated better from the winding.

In order to ensure a good connection of the longitudinal edges of the current collectors to the contact plate in such cells, it is expedient to use ribbon-shaped electrodes to form the winding, which are free of electrode material along one of their longitudinal edges, namely the longitudinal edge to be contacted. These ribbon-shaped electrodes therefore have a ribbon-shaped current collector on which a layer of a positive or negative electrode material is applied on both sides and which has a region along one of its longitudinal edges in which it is not covered with the electrode material on both sides. Along its second longitudinal edge, the current collector preferably has no such free edge region.

It is known to produce such ribbon-shaped electrodes in a coating process in which pasty electrode materials are applied to current collectors. The current collectors are usually ribbon-shaped metal foils. The electrode materials are applied using a slot die, for example, as described in EP 3 608 028 B1. Generally, one side of a ribbon-shaped metal foil is first coated with a strip of the electrode material in a tandem process. The strip coated on one side is then dried and wound up. In a later, further step, the second side of the ribbon-shaped metal foil is coated with the same electrode material, again in the form of a strip, and dried.

It is important that the strips of electrode material are ideally applied to both sides of the current collector without any offset, i.e. in such a way that the strips on both sides completely overlap in the viewing direction perpendicular to the ribbon-shaped metal foil. In particular, the regions on both sides of the current collector that are not covered with the electrode material should also have a constant width along the respective longitudinal edge over the entire length of the electrode. This is difficult to achieve with the tandem process described, and the required precision is often not achieved.

It is also already known to apply several parallel strips of an electrode material to both sides of a ribbon-shaped metal foil to produce electrode strips with free edge regions and then to cut the metal foil, for example between the strips, so that several ribbon-shaped electrodes result from the coated ribbon-shaped metal foil. However, the problem of misalignment between strips on different sides of the current collector also exists with this procedure.

To solve these problems, it has also been considered to mask off regions of the metal foil that are not to be coated with the electrode material and to remove the masking after coating has been completed. However, this procedure is extremely time-consuming, also because an additional step may generally be required to remove adhesive residues.

Another approach involves the subsequent removal of the coating in the longitudinal edge regions of the electrode strips, for example by laser or mechanically.

### SUMMARY

In an embodiment, the present disclosure provides a method of manufacturing ribbon-shaped electrodes that comprise a ribbon-shaped metal foil that acts as a current collector, are covered, on both a first side and a second side, with a layer of an electrode material, and have, on both the first side and the second side, a region extending along a longitudinal edge that is not covered with the electrode material. The method includes providing the ribbon-shaped metal foil and coating the ribbon-shaped metal foil with the electrode material in a continuous process to apply, via a plurality of application nozzles and simultaneously to the first side and to the second side, an equal number of parallel strips of the electrode material. In a direction perpendicular to the ribbon-shaped metal foil, each respective parallel strip on the first side overlaps with a respective parallel strip on the second side. On both the first side and the second side, an uncoated strip-shaped region between adjacent parallel strips of the electrode material remains free of the electrode material. The method further includes detecting an offset that exceeds a predefined threshold value between overlapping strips on the first side and the second side and correcting, in response to detecting the offset, a position of at least one of the application nozzles relative to the ribbon-shaped metal foil.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides schematic representations of five single-nozzle coating heads, each with an application nozzle for coating a first side of a ribbon-shaped metal foil (partial figure A) and schematic representations of a multi-nozzle coating head with five application nozzles for coating a second side of a ribbon-shaped metal foil (partial figure B);

FIG. 2 provides a schematic sectional view of the continuous, multi-lane and simultaneous coating of both sides of a ribbon-shaped metal foil in a first embodiment of a device;

FIG. 3 provides an isometric representation of the embodiment of the device shown in FIG. 2;

FIG. 4 provides a schematic sectional view of the continuous, multi-lane and simultaneous coating of both sides of a ribbon-shaped metal foil in a further embodiment of a device;

FIG. 5 provides an isometric representation of a device according to the embodiment shown in FIG. 4;

FIG. 6 provides a schematic sectional view of the continuous, multi-lane and simultaneous coating of both sides of a ribbon-shaped metal foil in a further embodiment of a device;

FIG. 7 provides an isometric representation of a further embodiment of a device for continuous, multi-lane and simultaneous coating of both sides of a ribbon-shaped metal foil;

FIG. 8 provides a flow diagram illustrating a preferred embodiment of the method; and

FIG. 9 provides a flow diagram illustrating a further preferred embodiment of the method.

### DETAILED DESCRIPTION

The known prior art methods of manufacturing ribbon-shaped electrodes with an edge region free of electrode material have therefore not yet led to satisfactory solutions that achieve the required precision of the coating, especially in mass production, while at the same time keeping the cost within acceptable limits.

Against this background, the present disclosure provides an improved method of manufacturing ribbon-shaped electrodes which have a ribbon-shaped current collector coated on both sides with electrode material, the latter having along one of its longitudinal edges an edge region which is not covered with the electrode material and which is provided for electrical contacting, for example with a contact plate. With a view to manufacturing in large quantities, it is desired to manufacture several ribbon-shaped electrodes in parallel, whereby the problem of a track offset between the coated regions of the ribbon-shaped electrodes should be addressed. The method should thus enable ribbon-shaped electrodes to be manufactured with great precision, while at the same time being suitable for mass production.

The present disclosure provides a method and a device as described below. The present disclosure further provides ribbon-shaped electrodes produced according to the method, the use of these ribbon-shaped electrodes, and electrochemical energy storage elements with such ribbon-shaped electrodes.

According to an aspect of the disclosure, a method is provided for manufacturing ribbon-shaped electrodes comprising a ribbon-shaped current collector. The current collector has two sides and is covered on both sides with a layer of an electrode material. Furthermore, the current collector has a region on both sides extending along one of its longitudinal edges that is not covered with electrode material. Along this longitudinal edge, the current collector is therefore free of electrode material on both sides. This region is intended for making electrical contact with the electrode, for example with a contact plate or the housing of an electrochemical energy storage cell or a battery.

The method of manufacturing such ribbon-shaped electrodes comprises the following method steps:
a. Provide a ribbon-shaped metal foil.
b. Coating the ribbon-shaped metal foil with an electrode material in a continuous process, a plurality of parallel strips of the electrode material being applied to the first side of the ribbon-shaped metal foil and an equal number of parallel strips of the electrode material being applied to the second side of the ribbon-shaped metal foil by means of application nozzles, so that, in the viewing direction perpendicular to the ribbon-shaped metal foil, in each case one strip on the first side overlaps with one of the strips on the second side of the ribbon-shaped metal foil, wherein on both sides between immediately adjacent parallel strips of the electrode material an uncoated strip-shaped region remains free of the electrode material.

The method is characterized by the following feature:
c. The parallel strips of electrode material are applied simultaneously to the first side and the second side of the ribbon-shaped metal foil.

Simultaneous application means that both sides of the ribbon-shaped metal foil are coated at the same time, in one operation and overlapping in time.

The process preferably comprises coating both sides of the metal foil in a single pass in a coating device, in particular a device for producing ribbon-shaped electrodes as described below. Particularly preferably, the coating on both sides can be carried out in a continuous throughput process, whereby both sides of the metal foil are coated simultaneously and, if necessary, spatially offset.

It is preferred not to coat one side of the metal foil first before the coating is applied to the other side in a separate operation, in each case with subsequent drying, like in conventional manufacturing processes. Rather, the method provides for the coating of the first and second sides to be carried out simultaneously. Multiple processing of the ribbon-shaped metal foil in successive coating operations, including the associated winding, unwinding, deflecting and calibrating operations, is not necessary. As a result, the problem of a possible offset between the strips on the first and second sides of the ribbon-shaped metal foil can be better addressed.

With conventional methods, an offset of overlapping strips on both sides of the metal foil of a few tenths of a millimeter is typical. Such deviations have a very detrimental effect on the performance of the electrodes. In addition, the non-optimal congruence of the strips can lead to problems during the subsequent processing of the electrodes into energy storage elements and the necessary electrical contacting of the electrodes. These disadvantages can be avoided with the disclosed manufacturing process, as the simultaneous coating process improves the precision of the strip application.

In the context of the present disclosure, the term “ribbon-shaped metal foil” is to be understood not only as a metallic foil in the actual sense, but more generally as any flat, ribbon-shaped substrate which has an electrical conductivity which is sufficiently high that it can serve as a current collector of an electrode. A ribbon-shaped substrate in this sense can therefore also be a graphite foil or a graphitized, metallized or otherwise film-like substrate with an electrically conductive coating for the production of ribbon-shaped electrodes. Other suitable strip-shaped substrates are also metal nets or metal grids or substrates based on metal foams or nonwovens made of metal filaments or metallized threads.

In preferred embodiments of the method, it is detected whether an offset occurs between overlapping strips on the first side and the second side and/or whether an offset exceeds a predefined threshold value. In preferred embodiments, an offset of the strips detected in this way is corrected by correcting the position of at least one of the application nozzles relative to the ribbon-shaped metal foil.

In a preferred and advantageous embodiment of the method, it is further characterized by at least one of the following additional features a. to c:
a. The strips of electrode material are applied using application nozzles.
b. It is detected, preferably with the aid of at least one sensor, whether an offset occurs between overlapping strips on the first side and the second side and/or whether an offset exceeds a predefined threshold value.
c. In the event of an offset between overlapping strips on the first side and the second side and/or if the predefined threshold value for the offset is exceeded, the position of at least one of the application nozzles relative to the ribbon-shaped metal foil is corrected.

The immediately preceding features a. to c. are preferably realized in combination.

In this preferred embodiment of the method, the actual offset occurring between the overlapping strips on the first side and the second side of the metal foil is detected and/or measured, so that corrective measures can be initiated if necessary. Preferably, the position of at least one of the application nozzles with which the strips of electrode material are applied is corrected accordingly for this purpose. In this embodiment of the method, it is therefore provided that the position of one or more application nozzles can be changed. After a short run-in phase during the coating of both sides of the ribbon-shaped metal foil, it is therefore possible to check whether there is a track offset, so that intervention and correction can be made very quickly if necessary. The control distance between the coating of the two sides is preferably short so that the coating tracks can be controlled individually. It can be advantageous if the coating is independent of other parameters, such as subsequent drying. This leads to highly accurate, congruent, double-sided and multi-lane coatings. In this way, a double-sided, multi-lane strip coating can be realized that does not require any subsequent corrections or subsequent reworking for highly accurate tracking.

In an advantageous embodiment of the method, the method is characterized by at least one of the following additional features a. and b:
a. The strips of electrode material are applied to at least one of the sides of the ribbon-shaped metal foil by means of several single-nozzle coating heads, each with an application nozzle, whose positions relative to one another can be varied.
b. Each of the single-nozzle coating heads is displaceable perpendicular to the direction of passage of the ribbon-shaped metal foil.

Particularly preferred are the aforementioned features a. and b. realized in combination with each other.

In this embodiment, where the single-nozzle coating heads are displaceable perpendicular to the direction in which the ribbon-shaped metal foil passes (preferably at a constant distance from the metal foil), the distance between the application nozzles and the edge of the metal foil can be varied so that the system can react to any offset that may occur during the coating of the two sides with respect to the overlapping strips on both sides of the metal foil and the position of one or more application nozzles can be corrected.

In principle, corresponding, adjustable single-nozzle coating heads can be provided on both sides of the ribbon-shaped metal foil in order to be able to make corrections on both sides of the metal foil during coating.

In preferred embodiments, however, at least one of the immediately following additional features is provided:
a. The strips of electrode material are applied to the first side of the ribbon-shaped metal foil by means of at least one multi-nozzle coating head comprising several application nozzles at fixed distances from one another,
b. the application of the strips of electrode material takes place on the second side of the ribbon-shaped metal foil by means of the single-nozzle coating heads, each with an application nozzle, whose positions can be varied relative to other application nozzles.

Preferably, the aforementioned features a. and b. are realized in combination with each other, so that on one side of the ribbon-shaped metal foil the coating is carried out with rigid application nozzles or with one or more multi-nozzle coating heads comprising several application nozzles at fixed distances from each other, while on the other side the coating of the ribbon-shaped metal foil is carried out with flexible application nozzles, in particular with several single-nozzle coating heads, which can be varied in their position.

Since in this embodiment the coating on one of the sides of the metal foil can be adjusted in the event of any misalignment, rigid application nozzles can be used on the other side without any further disadvantages, so that the use of the somewhat more complex flexible application nozzles can be limited to one side.

The first side and the second side mentioned here are in principle interchangeable. The rigid application nozzles can therefore be assigned to both an A-side and a B-side and the flexible application nozzles to both a B-side and an A-side when coating a metal foil.

In this advantageous embodiment of the method, a simultaneous double-sided and multi-lane coating of the two sides of the ribbon-shaped metal foil with electrode material takes place in a continuous method, as it were on a moving belt, whereby the coating of one side of the ribbon-shaped metal foil with an electrode material is carried out using one or, if necessary, several multi-nozzle coating heads with two or more rigidly arranged application nozzles. The coating of the other side of the ribbon-shaped metal foil with an electrode material is carried out using two or more single-nozzle coating heads, each with an application nozzle. In this case, the single-nozzle coating heads are arranged so that they can be moved across the width of the ribbon-shaped metal foil in such a way that the application of the electrode material can be adjusted and corrected by moving the single-nozzle coating heads to avoid an offset between the tracks of the electrode material on both sides of the metal foil.

Both the application nozzles of the multi-nozzle coating head and the application nozzles of the single-nozzle coating heads can be designed in accordance with EP 3 608 028 B1.

The detection of a possible offset between the overlapping strips on the first side and the second side of the ribbon-shaped metal foil can be carried out in different ways. Particularly preferred is the use of a sensor system that can detect this offset in an automated manner. In preferred embodiments of the method, at least one of the following additional features may be realized in this respect:
a. To detect a possible offset between overlapping strips on the first side and the second side of the ribbon-shaped metal foil, the distance of at least one of the strips from a longitudinal edge of the ribbon-shaped metal foil and/or a change in this distance is detected,
b. to detect a possible offset between overlapping strips on the first side and the second side of the ribbon-shaped metal foil, the distance of at least one of the strips from an adjacent strip and/or a change in this distance is detected,
c. To detect a possible offset between overlapping strips on the first side and the second side of the ribbon-shaped metal foil, the center lines of the strips and/or a change in the center lines are detected.

In preferred embodiments, the aforementioned features a. to c. can be realized alternatively. Preferably, however, two or three of the aforementioned features a. to c., in particular features a. and b., can also be realized in combination with one another.

A camera, for example, can advantageously be used as a sensor to detect the possible offset. In other embodiments, an edge sensor or similar can be used, for example. Another possibility is, for example, the measurement of light reflections, as the coated regions and the uncoated regions of the metal foil can be clearly distinguished from each other by their reflection properties.

In further preferred embodiments of the method, it may be provided that the positions and/or the boundaries of the strips applied to the first side of the metal foil are already determined after the coating of the first side, preferably by means of a sensor system. This information can be taken into account in the alignment and/or in a position correction of the application nozzles for the coating of the second side.

In preferred and advantageous embodiments of the method, the method is characterized by at least one of the following additional features:
a. After coating both sides of the ribbon-shaped metal foil, the strips of electrode material are dried.
b. The electrode material is dried in a flash dryer.

Preferably, the aforementioned features a. and b. are realized in combination with each other.

Drying the electrode materials immediately after they have been applied to the ribbon-shaped metal foil is generally expedient. Such drying is known in principle. The method can be distinguished from conventional methods in particular by the fact that the drying of the coating is carried out simultaneously on both sides of the ribbon-shaped metal foil, i.e. overlapping in time in one and the same work step. As a result, exactly the same conditions prevail for drying the coating on both sides of the ribbon-shaped metal foil, so that no further tolerances occur in the coatings on both sides and thus no further tolerances in the trace application due to the simultaneous drying. This measure also further improves the production of highly accurate and congruent strips of electrode material on both sides of the metal foil. In addition, simultaneous drying of the coatings improves the energy balance of the method.

The use of a flash dryer for drying is advantageous, as there is no contact between the freshly coated metal foil on both sides, for example with a roller or similar. For example, a vacuum plate in conjunction with air nozzles can be used for a flash dryer in a manner known per se.

As an alternative to drying both sides after coating on both sides of the ribbon-shaped metal foil, an additional intermediate drying step may also be advantageous. In these further embodiments of the method, it may be provided that, in the course of the method, an intermediate pre-drying or drying step takes place after the coating of the first side. In this case, the metal foil coated on one side can pass through a first drying device in a continuous method before the coating of the second side of the metal foil takes place. In this embodiment, both sides are also coated simultaneously, as this is a continuous throughput process. The intermediate drying has the particular advantage that the coating of the first side is so stable after drying that deflection rollers or the like can also engage the already coated side of the metal foil.

In particular, the coating process can also be applied to a so-called tandem coating process. Preferably, a position or boundary of the coating tracks on the first side of the metal foil is determined after leaving a first drying stage and is used for the alignment of the application nozzles of a second coating stage such that an offset of the coating tracks on the first side with respect to the coating tracks to be applied to the second side of the metal foil is minimized.

When applying several strips of an electrode material to the ribbon-shaped metal foil, it is advisable to cut the coated metal foil in the longitudinal direction in order to provide the ribbon-shaped electrodes to be produced from the metal foil in the desired width.

In preferred embodiments of the method, at least one of the following additional features is provided:
a. After coating both sides of the ribbon-shaped metal foil and/or after drying the electrode material, the ribbon-shaped metal foil coated with the electrode material is cut, in particular cut in the longitudinal direction, to form the ribbon-shaped electrodes,
b. To cut the ribbon-shaped metal foil, the foil is cut longitudinally, whereby a cut is made through at least one of the uncoated strip-shaped regions arranged between adjacent strips of the electrode material,
c. To cut the ribbon-shaped metal foil, the foil is cut lengthwise, cutting through at least one of the strips.

Preferably, the aforementioned features a. to c. are realized in combination with each other.

In these embodiments, the uncoated strip-shaped regions between adjacent strips of the electrode material are preferably divided, in particular cut, centrally in the longitudinal direction and the strips of the electrode material are divided centrally in the longitudinal direction, so that several electrodes can be provided from the metal foil. The required length of the ribbon-shaped electrode can be subsequently cut accordingly, depending on the desired dimensions of the energy storage element to be produced.

The width of the ribbon-shaped metal foil can be adapted to the number and dimensions of the ribbon-shaped electrodes to be produced. Preferably, two strips, three strips, four strips or five strips can be applied congruently on both sides of the metal foil. By cutting once in the longitudinal direction, for example, two ribbon-shaped electrodes can be obtained from a two-lane strip of the electrode material applied on both sides.

Particularly preferably, three to eight strips of the electrode material can be applied to both sides of the ribbon-shaped metal foil, for example, so that six to sixteen electrode strips can be cut from it, which in turn can be cut into different lengths depending on the size of the energy storage cells to be produced.

In preferred embodiments, the width of the ribbon-shaped metal foil can be, for example, 100 to 1000 mm, preferably about 200 to 800 mm. The strips of the electrode material typically have a width in a range from 20 mm to 200 mm, preferably from 50 mm to 150 mm. Their thickness is preferably below 500 μm. The length of the ribbon-shaped metal foil can be 1000 to 3000 m, for example.

Conventional materials known to the skilled person for the manufacture of electrochemical energy storage elements can be used as materials for the ribbon-shaped electrodes. For example, conventional anodic electrode materials and cathodic electrode materials can be used as electrode materials, whereby the ribbon-shaped metal foil is either coated on both sides with an anodic electrode material or on both sides with a cathodic electrode material.

The method is suitable for the production of ribbon-shaped electrodes for lithium-ion cells.

Secondary lithium-ion cells are used as energy storage elements for many applications, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. In particular, oxidic metal compounds that can reversibly intercalate lithium, such as lithium cobalt oxide (LiCoO₂), lithium manganese oxide (LiMn₂O₄), lithium iron phosphate (LiFePO₄) or derivatives thereof, can be used as active materials for the positive electrode. The electrode material used in the context of the present disclosure may comprise these electrochemically active materials, in particular in particulate form.

A further component of the composite electrodes is the current collector, which in the ribbon-shaped electrodes is formed in the form of a strip from the ribbon-shaped metal foil. The current collector serves as a carrier for the respective active material. The current collector for the negative electrode (anode current collector) can be made of copper or nickel, for example, and the current collector for the positive electrode (cathode current collector) can be made of aluminum, for example. Accordingly, the metal foil that is coated with electrode material as part of the method also preferably consists of aluminum, nickel or copper.

Furthermore, the electrodes (and thus also the electrode material used in the context of the present disclosure) can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

According to a further aspect, the disclosure provides a device for producing the ribbon-shaped electrodes already described. This device comprises the following features:
a. The device comprises a conveyor section for conveying a ribbon-shaped metal foil, which has a first and a second side, in the direction of passage parallel to the longitudinal direction of the metal foil,
b. the device comprises a plurality of application nozzles which serve to coat the first side of the ribbon-shaped metal foil and the second side of the ribbon-shaped metal foil with an electrode material and are positioned accordingly,
c. the application nozzles are positioned in such a way that a plurality of parallel strips of the electrode material can be applied to the first side of the ribbon-shaped metal foil and an equal number of parallel strips of the electrode material can be applied to the second side of the ribbon-shaped metal foil, so that, in the viewing direction perpendicular to the ribbon-shaped metal foil, one strip on the first side overlaps with one of the strips on the second side of the ribbon-shaped metal foil, wherein on both sides between immediately adjacent parallel strips of the electrode material an uncoated strip-shaped region remains free of the electrode material,
d. the device is set up for simultaneous coating of the first side and the second side of the ribbon-shaped metal foil by means of the application nozzles.

The device is set up for the continuous coating of the continuous ribbon-shaped metal foil, which forms the material of the current collectors of the ribbon-shaped electrodes to be produced, whereby corresponding rollers and deflection rollers as well as coating rollers can be provided for this purpose in a manner known in principle in order to transport the ribbon-shaped metal foil in the continuous direction.

In a preferred manner, the device is set up such that it detects whether an offset occurs between overlapping strips on the first side and the second side and/or whether an offset exceeds a predefined threshold value, so that any offset that may occur can preferably be corrected by correcting the position of one or more application nozzles.

In particular, the application nozzles, which are set up for coating the first side and/or the second side of the metal foil, can each be assigned a coating roller opposite one another, so that the application nozzle is located on one side and the coating roller is located on the other side, so that the coating roller exerts a counterpressure on the metal foil during the coating process.

The application nozzles for coating one side and for coating the other side are preferably arranged offset to one another in the direction of flow, so that one side of the ribbon-shaped metal foil is coated before the other in the direction of flow, with the metal foil preferably being guided between the two coating positions via a deflection roller in order to bring the ribbon-shaped metal foil into a suitable position for coating.

With regard to the application nozzles for the coating, the device is characterized in a preferred manner by at least one of the following features:
a. The device comprises several single-nozzle coating heads, each with an application nozzle, whose positions can be varied in relation to each other,
b. the single-nozzle coating heads are displaceable perpendicular to the direction of passage of the ribbon-shaped metal foil.

Preferably, the directly aforementioned features a. and b. are realized in combination with each other.

These preferably displaceable single-nozzle coating heads are preferably provided in the device on only one side of the ribbon-shaped metal foil to be coated. In principle, however, single-nozzle coating heads can also be provided for coating on both sides of the metal foil, the positions of which can be varied relative to one another. Embodiments with variable single-nozzle coating heads for both sides of the metal foil can be advantageous under certain circumstances, as this allows particular flexibility in correcting any track offset that may occur.

It is preferred that the device is characterized by the following additional features:
a. The device comprises at least one multi-nozzle coating head comprising a plurality of application nozzles at fixed distances from each other, the at least one multi-nozzle coating head being aligned to coat one side of the ribbon-shaped metal foil,
b. the device comprises several single-nozzle coating heads, each with an application nozzle, the positions of which can be varied relative to one another, the single-nozzle coating heads being aligned to coat the other side of the ribbon-shaped metal foil.

Preferably, the aforementioned features a. and b. are realized in combination with each other, so that rigidly arranged coating nozzles are assigned to one side of the metal foil passing through the device and application nozzles of the aforementioned single-nozzle coating heads are assigned to the other side of the metal foil. In this embodiment of the device in particular, it is possible in a less complex manner to react to any offset that may occur between the overlapping strips on both sides of the ribbon-shaped metal foil and to adjust the position of the application nozzles on one side of the ribbon-shaped metal foil accordingly. For this purpose, the device expediently comprises a corresponding device for shifting the position of the single-nozzle coating heads to avoid an offset between the application of the electrode material on both sides of the ribbon-shaped metal foil.

In a preferred manner, the device is further characterized by at least one of the following additional features:
a. The single-nozzle coating heads are arranged offset to each other in relation to the direction of passage of the ribbon-shaped metal foil to be coated,
b. the single-nozzle coating heads are arranged in two rows perpendicular to the direction of passage of the ribbon-shaped metal foil to be coated.

Preferably, the aforementioned features a. and b. are realized in combination with each other.

These arrangements of the single-nozzle coating heads allow space-saving arrangements of the single-nozzle coating heads, while at the same time ensuring freedom of movement or displaceability of the application nozzles transverse to the direction of passage of the ribbon-shaped metal foil.

In further preferred embodiments of the device, it may be provided that the application nozzles and, in particular, the single-nozzle coating heads can also be moved perpendicular to the plane of the metal foil and can thus be raised and lowered again as required. This enables and/or facilitates intermittent coating when applying the tracks to the metal foil. Preferably, the individual single-nozzle coating heads can also be moved independently of each other in this direction so that they can be raised and lowered individually depending on the pattern to be applied.

In advantageous embodiments, the device is further characterized by at least one of the following additional features:
a. The device comprises a sensor system for detecting a possible offset between overlapping strips on the first side and the second side of the ribbon-shaped metal foil,
b. the device comprises a drying device for the coated ribbon-shaped metal foil, preferably a floating dryer,
c. the device comprises a cutting device, in particular a cutting device for severing or cutting the coated ribbon-shaped metal foil in the longitudinal direction.

Preferably, the device comprises a sensor system for detecting a possible offset between the overlapping strips on both sides of the ribbon-shaped metal foil according to the above-mentioned feature a. and a drying device according to the above-mentioned feature b. and a cutting device according to the above-mentioned feature c.

Details of the sensor system and the drying device have already been described in the context of the method. Reference is hereby made to the corresponding explanations.

The device also preferably comprises a device, for example a control unit, for evaluating the measured values recorded by the sensor system and for converting these measured values into a correction relating to the position of the application nozzles.

The cutting device can be a conventional cutting device that works with suitable blades or lasers, for example.

The disclosure further encompasses a control program for a device for manufacturing ribbon-shaped electrodes in the manner described above, this control program being set up to carry out the method of manufacturing ribbon-shaped electrodes as described above. In particular, this control program can be used to correct the position of the application nozzles for the coating in the event of any offset in the overlapping strips of applied electrode material on both sides of the ribbon-shaped metal foil.

The disclosure further comprises ribbon-shaped electrodes produced by the described method. With regard to further details of these ribbon-shaped electrodes, reference is made to the above description.

Furthermore, the disclosure comprises the use of ribbon-shaped electrodes produced by the method for manufacturing an electrochemical energy storage element, in particular an electrochemical energy storage cell or a battery composed of a plurality of electrochemical energy storage cells. Said energy storage elements are also provided by the disclosure.

When manufacturing the electrochemical energy storage element, the ribbon-shaped electrodes are preferably contacted via the edge regions of the electrode strips that are free of electrode material. For example, a contact plate can be provided for contacting the electrodes or other elements of the housing of the energy storage element can be used for contacting the electrodes.

In preferred embodiments, the ribbon-shaped electrodes are used to produce lithium-ion cells.

With regard to further features of the ribbon-shaped electrodes, which are part of these electrochemical energy storage elements, and with regard to the method of manufacturing these ribbon-shaped electrodes, reference is made to the above description.

Further features and advantages are apparent from the following description of examples in conjunction with the drawings. The individual features can be realized individually or in combination with each other.

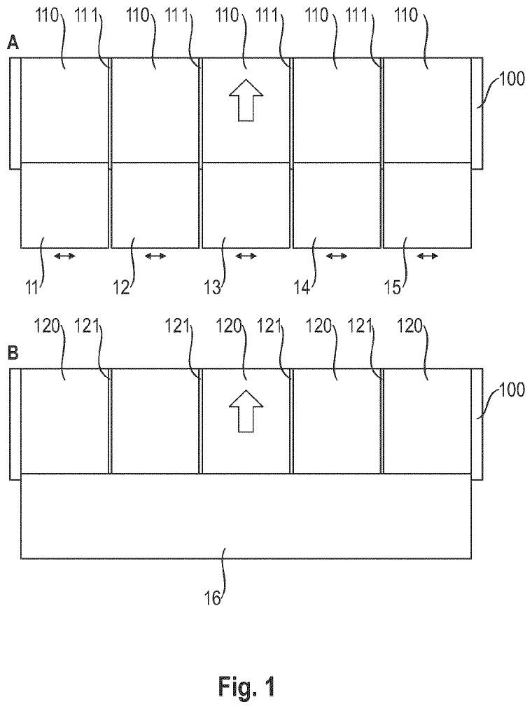

FIG. 1 schematically illustrates the coating of both sides of a ribbon-shaped metal foil. For the coating of a first side of the ribbon-shaped metal foil 100, five coating heads 11, 12, 13, 14, 15 are provided in the example shown here (partial figure A), which are each designed as single-nozzle coating heads and accordingly each comprise an application nozzle. These single-nozzle coating heads 11-15 can each be used to apply a track 110 or a strip of electrode material when coating the ribbon-shaped metal foil 100. Each track 110 forms a strip of the electrode material on one side of the ribbon-shaped metal foil 100. A narrow uncoated strip-shaped region 111 is located between each of the individual strips 110. All strips are aligned parallel to one another.

For coating the other side of the ribbon-shaped metal foil 100, a multi-nozzle coating head 16 is provided (sub-figure B), which in this example comprises five rigidly arranged application nozzles, which are provided for applying five parallel strips 120 of electrode material to the other side of the ribbon-shaped metal foil 100. Accordingly, narrow uncoated strip-shaped regions 121 are provided between the individual parallel strips 120 as on the other side of the metal foil 100.

The strips are applied to both sides of the ribbon-shaped metal foil 100 such that the strips 110 on one side overlap with the strips 120 on the other side (in the viewing direction perpendicular to the metal foil), the invention addressing the problem of avoiding an offset between the strips 110, 120 on both sides of the metal foil 100.

For this purpose, the invention initially provides for the simultaneous application of the strips 110 and 120 to both sides of the metal foil 100 in one operation. Thus, unlike conventional methods, one side is not first coated and dried before the other side is coated and dried. Rather, the invention provides that both sides are coated simultaneously with a temporal overlap and preferably also dried simultaneously.

In a preferred manner, the coating is carried out on one side of the metal foil 100 in such a way that the coating is carried out with single-nozzle coating heads whose position relative to the metal foil and relative to each other can be adapted to any offset that may occur.

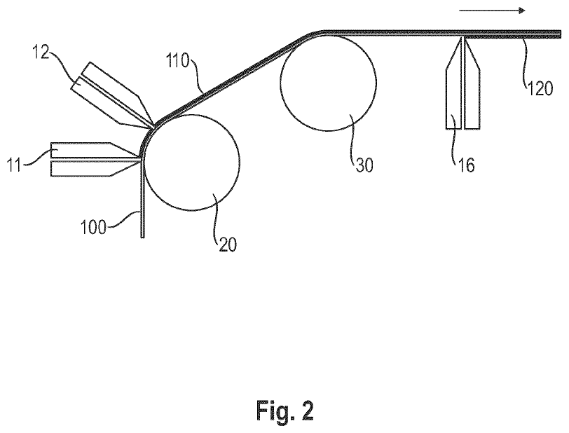

FIG. 2 shows a preferred embodiment of a device. Several single-nozzle coating heads 11-15 are provided for coating one side (A side), whereby only the single-nozzle coating heads 11 and 12 are indicated in this sectional view shown in FIG. 2. The position of these separately formed coating heads 11 and 12 can be adjusted transversely to the width of the metal foil 100 to be coated, so that it is possible to react to any misalignment that may occur. The single-nozzle coating heads 11 and 12 or all single-nozzle coating heads 11-15 work against a coating roller 20 and ensure that an electrode material is applied to the ribbon-shaped metal foil 100 in several tracks (strips), for example five tracks (parallel strips 110) on the A-side. The metal foil 100 is guided over a deflection roller 30 and thus reaches the multi-nozzle coating head 16, by means of which the coating 120, also in multiple tracks, is applied to the other side (B side) of the ribbon-shaped metal foil 100.

The metal foil 100, which is coated on both sides and in multiple lanes, continues in the direction of the arrow to a drying device not shown here. Subsequently, the metal foil 100 can be cut several times in the longitudinal direction, preferably within the uncoated strip-shaped regions 111, 121 and in the center of the parallel strips 110, 120 of electrode material.

When five parallel strips are applied to both sides of the metal foil 100, a total of ten ribbon-shaped metal foils coated on both sides can thus be obtained, each of which has a region extending along one of its longitudinal edges and uncovered on both sides by electrode material, which can be used for contacting the electrode strips.

The adjustability of the flexible single-nozzle coating heads 11-15, which are used for coating the A side in the example shown in FIG. 2, means that if an offset occurs during the application of the strips 110, 120 on both sides of the metal foil, the application on the A side can be corrected so that a track offset is reliably corrected and thus avoided.

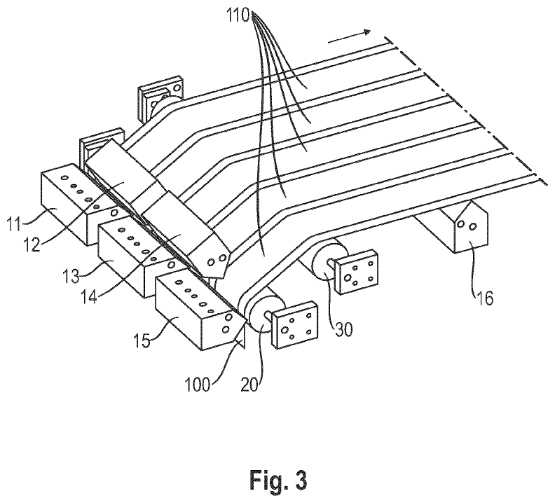

FIG. 3 shows an isometric representation of the device shown schematically in section in FIG. 2. The single-nozzle coating heads 11-15 are offset and arranged in two rows. The single-nozzle coating heads 11, 13 and 15 are arranged in the first row, while the coating heads 12 and 14 are arranged offset in a second row. In this space-saving arrangement of the single-nozzle coating heads 11-15, the single-nozzle coating heads 11-15 can be adjusted transversely to the running direction of the ribbon-shaped metal foil without obstructing each other, so that if an offset occurs between the tracks 110 and in the tracks 120 not visible here on the opposite side of the metal foil 100, the track application can be corrected on the A-side located here at the top of the tracks 110.

Not shown here is a sensor system that measures any track offset that may occur between the tracks or strips 110 and 120. For example, several cameras can be provided for this purpose, which monitor the track application on both sides of the metal foil 100.

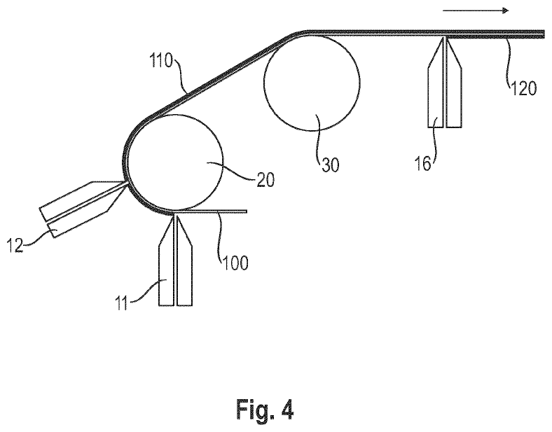

FIG. 4 shows a further embodiment of a device suitable for double-sided coating. Comparable to the device shown in FIG. 2, two flexible single-nozzle coating heads 11 and 12 can also be seen in the schematic sectional view shown here, which are set up in interaction with the coating roller 20 for coating the A-side of the ribbon-shaped metal foil 100. Not visible here are the other single-nozzle coating heads 13, 14 and 15, which are distributed across the width of the metal foil 100 to be coated and are assigned to the A-side of the metal foil 100. These single-nozzle coating heads 11-15 ensure the multi-track coating in the form of several parallel strips 110 on the A-side of the metal foil 100. Here too, the metal foil 100, which has already been coated on one side, is guided via the deflection roller 30 to the multi-nozzle coating head 16 for coating the B-side of the metal foil 100 to form the parallel strips 120 of electrode material on the B-side of the metal foil 100. In contrast to the device shown schematically in section in FIG. 2, the device in FIG. 4 has a larger deflection angle for the metal foil 100 to be coated due to the coating roller 20. The flexible single-nozzle coating heads 11-15 are aligned at a different angle in relation to the curvature of the metal foil 100.

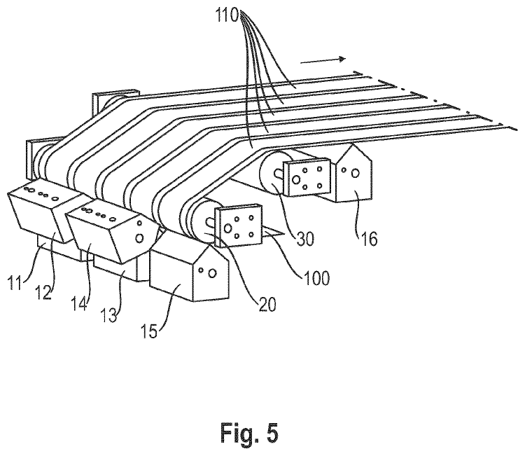

FIG. 5 shows an isometric representation of the device of FIG. 4, which is provided with corresponding reference numbers. Comparable to the illustration in FIG. 3, the offset arrangement of the single-nozzle coating heads 11-15 in two rows in relation to the running direction of the metal foil 100 to be coated can be seen.

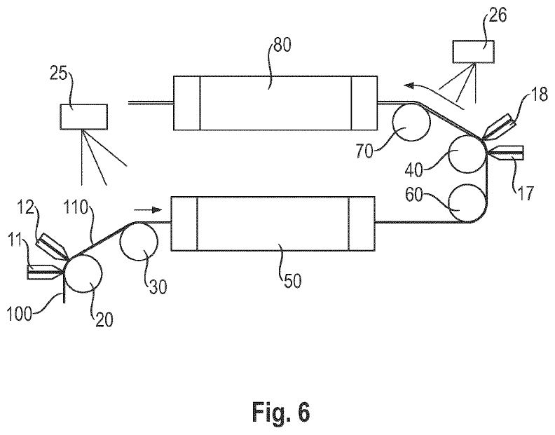

FIG. 6 illustrates in schematic sectional view a further embodiment of a device for coating both sides of a ribbon-shaped metal foil 100. In this embodiment, a plurality of flexible single-nozzle coating heads are provided both for one side (A side) and for the other side (B side), two single-nozzle coating heads 11, 12 and 17, 18 being shown in each case in this embodiment, which are representative of, for example, five single-nozzle coating heads arranged offset to one another in each case.

The single-nozzle coating heads 11, 12 and 17, 18 each work against a coating roller 20 or 40 and ensure that the electrode material is applied to the ribbon-shaped metal foil 100 in several tracks (strips), for example five tracks (parallel strips 110) on the A-side and subsequently on the B-side. Since in this example the coating of the B-side is also carried out against a coating roll, upstream drying of the A-side is provided.

This arrangement is a tandem coater with two multilane coating head zones, whereby in at least one of these zones the coating heads 11, 12 and 17, 18 can be moved perpendicular to the transport direction of the metal foil in order to be able to make flexible track offset corrections.

Sensor 25 can be used to check whether stripes are offset from a target position when applying the coating to the A side. Sensor 26 can be used to check whether a strip offset occurs when the coating is applied to the B side. The sensor can be a camera, for example.

Before the coating of the B side takes place, the metal foil 100 already coated on one side passes through a first drying device 50 in this embodiment, before the metal foil coated on one side is guided via a deflection roller 60 into the region with the coating heads 17, 18 for the multi-track coating of the B side.

The metal foil 100, which is coated on both sides and in multiple tracks, continues in the direction of the arrow over a further roll 70 to a further drying device 80. Subsequently, if necessary after calendering (compaction) of the electrode material, the metal foil 100 can be cut several times in the longitudinal direction, preferably within the uncoated strip-shaped regions 111, 121 and in the middle of the parallel strips 110, 120 of electrode material.

The intermediate drying of the A-side has the particular advantage that (deflection) rollers can also engage with the already coated A-side, so that the metal foil can be guided in such a way that the application nozzles for both the A-side and the B-side can apply from the side or from above and do not have to work from below, i.e. against gravity.

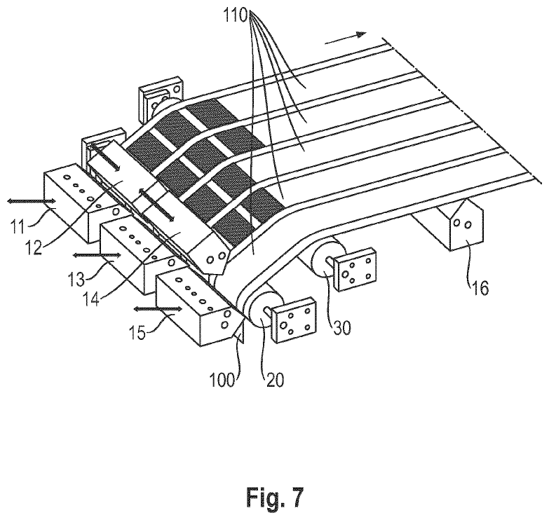

FIG. 7 shows a further embodiment of a device, which is largely comparable to the embodiment shown in FIG. 3. The corresponding elements of the device are provided with the same reference numbers.

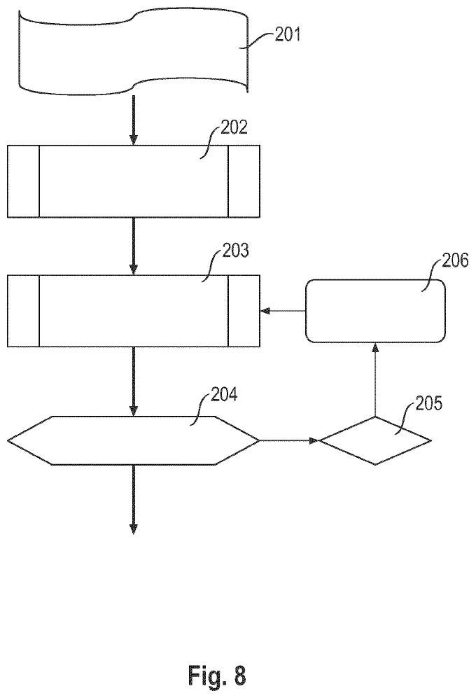

In contrast to the embodiment shown in FIG. 3, the single-nozzle coating heads 11, 12, 13, 14, 15 can also be moved perpendicular to the track plane (indicated by double arrows). This enables and/or facilitates intermittent coating during the application of the tracks 110. Preferably, the individual single-nozzle coating heads 11, 12, 13, 14, 15 can also be moved independently of one another in this direction, so that they can be raised and lowered individually, depending on the pattern to be applied. FIG. 8 illustrates a preferred embodiment of the method in the form of a flow diagram. The method features explained as individual steps are to be understood in such a way that the steps can run in parallel in one pass of the method for coating both sides of the metal foil, whereby the metal foil to be coated runs continuously through the coating method as an endless belt, so to speak. The sequence of the steps reflects the spatial arrangement of the corresponding device components, for example the corresponding coating heads, for carrying out the steps within a coating device.

After the ribbon-shaped metal foil has been provided in step 201, a strip-shaped coating is applied to the first side of the metal foil (step 202) and a strip-shaped coating is applied to the second side of the metal foil (step 203) in a continuous process. Step 202 and step 203 are carried out simultaneously by placing corresponding coating heads on both sides of the metal foil as it passes through and, if necessary, applying the coating to both sides of the metal foil at a spatial distance from one another as the metal foil passes through. In step 204, it is checked during the pass whether a strip offset occurs between the coatings on both sides of the metal foil and/or whether a predetermined threshold value is exceeded in the event of a detectable strip offset. This determination of the strip offset is carried out in particular with the aid of one or more sensors. If a strip offset or a strip offset above a predetermined threshold value is detected (step 205), a position correction of the coating heads for coating the second side of the metal foil (step 203) is carried out in step 206 while coating is in progress. If no strip offset or a strip offset below a predetermined threshold value is detected in step 204, the coating of the metal foil can be continued with unchanged parameters.

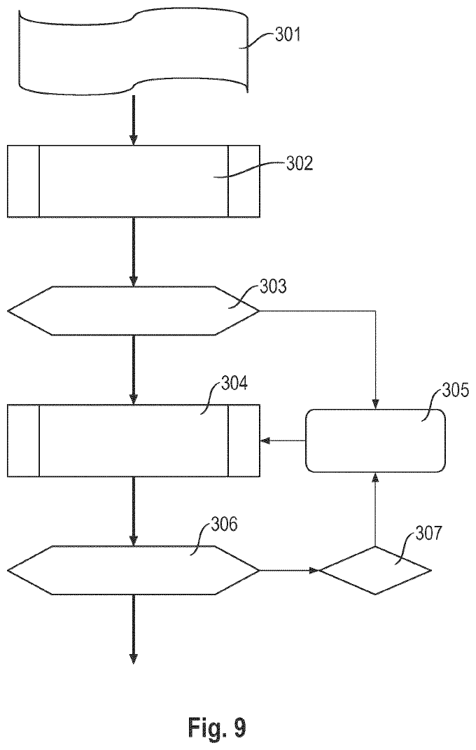

FIG. 9 illustrates a further preferred embodiment of the method in the form of a flow chart. As in the flow diagram according to FIG. 8, the method features explained as individual steps are to be understood in such a way that the steps run overlapping in time in one pass of the method for coating both sides of the metal foil, whereby the metal foil to be coated runs continuously through the coating method virtually as an endless belt. The sequence of the steps reflects the spatial arrangement of the corresponding device components for carrying out the steps within a coating device.

After the ribbon-shaped metal foil has been provided in step 301, a strip-shaped coating is applied to the first side of the metal foil in a continuous process (step 302). In step 303, the strip boundaries and/or strip positions are determined for the coating already applied to the first side. In step 304, the second side of the metal foil is coated in strips. Step 302 and step 304 are preferably carried out simultaneously, in that coating heads are applied to both sides of the metal foil and, if necessary, the coating is applied in one pass of the metal foil at a spatial distance from one another. The data determined in step 303 can be incorporated in step 305 into a position correction of the coating heads for the strip-shaped coating of the second side of the metal foil in step 304. In step 306, it is checked whether a strip offset occurs during the application of the coating of the second side and/or whether a predetermined threshold value is exceeded if a strip offset can be detected. If a strip offset or a strip offset above a predetermined threshold value can be detected (step 307), this is included in the position correction of the coating heads (step 305) for the coating of the second side of the metal foil (step 304). If no strip offset or a strip offset below a predetermined threshold value is detected in step 306, the coating of the metal foil can be continued with unchanged parameters.

The determination of the strip offset in step 303 and the determination of the strip boundaries and/or strip positions in step 306 are carried out in particular with the aid of one or more sensors, for example with a camera or an edge sensor.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of manufacturing ribbon-shaped electrodes that comprise a ribbon-shaped metal foil that acts as a current collector, are covered, on both a first side and a second side, with a layer of an electrode material, and have, on both the first side and the second side, a region extending along a longitudinal edge that is not covered with the electrode material, the method comprising:
providing the ribbon-shaped metal foil,
coating the ribbon-shaped metal foil with the electrode material in a continuous process to apply, via a plurality of application nozzles and simultaneously to the first side and to the second side, an equal number of parallel strips of the electrode material, wherein, in a direction perpendicular to the ribbon-shaped metal foil, each respective parallel strip on the first side overlaps with a respective parallel strip on the second side, and wherein, on both the first side and the second side, an uncoated strip-shaped region between adjacent parallel strips of the electrode material remains free of the electrode material,
detecting an offset that exceeds a predefined threshold value between overlapping strips on the first side and the second side, and
correcting, in response to detecting the offset, a position of at least one of the application nozzles relative to the ribbon-shaped metal foil.

2. The method according to claim 1, wherein at least one of:
at least a subset of the plurality application nozzles is provided by a plurality of single-nozzle coating heads whose positions relative to one another are configured to be varied, and/or
each of the single-nozzle coating heads is configured to be displaced in a direction perpendicular to a direction of passage of the ribbon-shaped metal foil.

3. The method according to claim 2, wherein:
the parallel strips of the electrode material applied to the first side of the ribbon-shaped metal foil are applied via at least one multi-nozzle coating head comprising a plurality of application nozzles at fixed distances from one another,
the parallel strips of the electrode material applied to the second side of the ribbon-shaped metal foil are applied via single-nozzle coating heads whose positions can be varied relative to other application nozzles.

4. The method according to claim 1, wherein at least one of:
detecting the offset comprises detecting, for at least one respective strip, a distance from a longitudinal edge of the ribbon-shaped metal foil and/or a change in the distance from the longitudinal edge of the ribbon-shaped metal foil,
detecting the offset comprises detecting, for at least one respective strip, a distance of the respective strip from an adjacent strip and/or a change in the distance of the respective strip, and/or
detecting the offset comprises detecting, for at least one respective strip, a distance of a center line of the respective strip and/or a change in the center line of the respective strip.

5. The method according to claim 1, further comprising at least one of:
drying the strips of electrode material after coating both sides of the ribbon-shaped metal foil, and/or
drying the electrode material in a flash dryer.

6. The method according to claim 1, further comprising at least one of:
cutting, after coating the ribbon-shaped metal foil, the ribbon-shaped metal foil to form the ribbon-shaped electrodes,
cutting the ribbon-shaped metal foil in a longitudinal direction through at least one uncoated strip-shaped region, and/or
cutting the ribbon-shaped metal foil longitudinally, with a cut being made through at least one of the strips.

7. A device for producing ribbon-shaped electrodes that comprise a ribbon-shaped metal foil that acts as a current collector, is covered, on both a first side and a second side, with a layer of an electrode material, and has, on both the first side and the second side, a region extending along a longitudinal edge that is not covered with the electrode material, the device comprising:
a conveyor section configured to convey the ribbon-shaped metal foil in a direction of passage parallel to a longitudinal direction of the metal foil; and
a plurality of application nozzles configured to coat the first side of the ribbon-shaped metal foil and the second side of the ribbon-shaped metal foil with the electrode material,
wherein the application nozzles are positioned such that they are configured to apply, simultaneously to the first side and the second side of the ribbon-shaped metal foil, an equal number of parallel strips of the electrode material, wherein, in a direction perpendicular to the ribbon-shaped metal foil, each respective parallel strip on the first side overlaps with a respective parallel strip on the second side, wherein, on both the first side and the second side, an uncoated strip-shaped region between adjacent parallel strips of the electrode material remains free of the electrode material, and
wherein the device is configured to detect an offset that exceeds a predefined threshold value between overlapping strips on the first side and the second side.

8. The device according to claim 7, wherein at least one of:
the device comprises a plurality of single-nozzle coating heads, each comprising a respective application nozzle of the plurality of application nozzles, wherein positions of the single-nozzle coating heads are configured to be varied in relation to one another, and/or
the plurality of single-nozzle coating heads are displaceable perpendicular to the direction of passage of the ribbon-shaped metal foil.

9. The device according to claim 7, wherein:
device comprises at least one multi-nozzle coating head comprising a subset of the plurality of application nozzles at fixed distances from each other, wherein the at least one multi-nozzle coating head is aligned to coat the first side of the ribbon-shaped metal foil,
the device comprises a plurality of single-nozzle coating heads, each comprising a respective application nozzle of the plurality of application nozzles, wherein positions of the single-nozzle coating heads are configured to be varied relative to one another, and
the single-nozzle coating heads are aligned to coat the second side of the ribbon-shaped metal foil.

10. The device according to claim 9, wherein:
the plurality of single-nozzle coating heads are offset relative to each other with respect to the direction of passage of the ribbon-shaped metal foil, and/or
the single-nozzle coating heads are arranged in two rows perpendicular to the direction of passage of the ribbon-shaped metal foil.

11. The device according to claim 7, wherein at least one of:
the device comprises a sensor system configured to detect the offset,
the device comprises a dryer for drying the coated ribbon-shaped metal foil,
the device comprises a cutting device, and/or
the cutting device is configured to cut the ribbon-shaped metal foil in the longitudinal direction.

12. A ribbon-shaped electrode produced by the method according to claim 1.

13. The use of ribbon-shaped electrodes according to claim 12 for the manufacture of an electrochemical energy storage element.

14. An electrochemical energy storage element, comprising:
at least one ribbon-shaped electrode produced by the method according to claim 1.

15. The method according to claim 1, wherein the predefined threshold value is zero.

16. The device according to claim 7, wherein the predefined threshold value is zero.
